(19) United States
(12) Patent Application Publication
(10) Pub. No.: US 2007/0073858 A1
(43) Pub. Date: Mar. 29, 2007

(54) Security of virtual computing platforms

(75) Inventors: Ram Gopal Lakshmi Narayanan, Hudson, NH (US); Tat Keung Chan, San Diego, CA (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/237,484

(22) Filed: Sep. 27, 2005

(51) Int. Cl. G06F 15/173

(52) U.S. Cl. 709/223; 709/238

(57) ABSTRACT

The invention relates to a virtual computing platform for providing subscribers of the virtual computing platform with means for running their applications on the platform instead of running the applications on their mobile devices. The virtual computing platform is adapted to route internal communication directed from a first application of the platform to a second application of the platform via a set of external security appliances. The set may include a firewall, a security gateway, an application layer firewall, a web shield, an anti-virus device and an anti-spam device.

### FIELD OF THE INVENTION

The invention generally relates virtual computing platforms. More particularly, but not exclusively, the invention relates to securing distributed virtual computing platforms for mobile devices as well as for non-mobile devices.

### BACKGROUND OF THE INVENTION

A generic distributed virtual computing platform provides an environment in a network for mobile users to host a service instead of running it on their mobile terminals, where there are limitations in computing, storage, as well as communication resources. Users are allowed to push their services to, and subsequently host their services on the virtual computing platform. As an example, a subscriber may host a web server on the platform, rather than having it on his/her mobile terminal. The same virtual computing platform may also be used by application developers for developing peer-to-peer applications (e.g., gaming applications).

The virtual computing platform is not limited for use of mobile users only, but can also be used by non-mobile devices. A subscriber having a non-mobile or fixed terminal may decide to run some services on the virtual computing platform as well, e.g., the subscriber may not be running her own desktop computer all the time, and to make his/her services available all the time, he/she can host the services on such a virtual computing platform.

In the following, the architecture of a generic distributed virtual computing platform is described in more detail. A distributed virtual computing platform is a virtualization of hardware resources that the operator or third-party service provider provides, as a unified view, to the subscribers. The term “operator” and the “service provider” that provides this kind of virtual computing platform service for devices can generally be used interchangeably. In the following description, the term operator will be used.

FIG. 1 shows a generic framework for the distributed virtual computing platform under considerations. It describes the entities that are involved in virtual computing platform services provided by the operator. These include:
Service platform: The service platform 100 (FIG. 1) refers to the distributed virtual computing platform provided by the operator.
Subscriber: In the following, subscribers refer to subscribers of the virtual computing platform service, who can deploy and maintain their applications on the virtual computing platform instead of running them on their personal devices, such as mobile or fixed terminals 101, 102 (FIG. 1). Subscribers of the virtual computing platform service are not to be confused with mobile service subscribers, who subscribe to mobile communication services from mobile operators.
Service deployer: The service deployer is a piece of software that a subscriber uses to deploy his/her applications to the virtual computing platform. The deployer can be run either on a mobile device or any networked device (such as a PC).
Service proxy: The service proxy is an instance of virtual computing machine on the virtual computing platform, which is responsible for hosting the various applications deployed by a particular subscriber. For example, a subscriber may be hosting a web server and an FTP server on his/her service proxy. FIG. 1 shows that the owner of the mobile device or terminal 101 is running his/her application(s) in the proxy 111 (Proxy 1), and the owner of the non-mobile device or fixed terminal 102 is running his/her application(s) in the proxy 112 (Proxy 2).
Applications: Applications refer to the applications that are running on a particular service proxy by the subscriber. Examples include a web server, an FTP server, a gaming server, etc.
Service client: Service clients are clients who may be accessing the applications hosted by a certain service subscriber. In the web server example, a service client will be any user accessing the web server using a browser. The service client can access the web server from the Internet, such as clients 140-142 in FIG. 1, as well as from a mobile network or from a local network 103.
Service management daemon: A service management daemon 105 (FIG. 1) is a process in the virtual computing platform responsible for the management of various service proxies, service deployments, and so on. For instance, the service management daemon will listen on certain ports for service deployers' requests to deploy/modify applications running in the service proxies. It is also responsible for authentication of these requests, allocating resources on the platform, etc.

A generic virtual computing platform allows multiple users to host applications on the same physical machine, namely, the service platform. FIG. 2 shows the internal architecture of the service platform 100. In practice, the service platform 100 can be implemented, for example, by a powerful computing machine running a suitable operating system 160, such as Linux or hardened Linux operating system (OS). In one example, Java Virtual Machine (VM) technology 150 can be used to allow multiple subscribers to share the resources of the service platform. In FIG. 2, two service proxies are running. Service proxy 111 (proxy 1) belongs to subscriber 1 (not shown), and service proxy 112 (proxy 2) belongs to subscriber 2 (not shown). Subscriber 1 is hosting two different applications or services on the platform, namely, application A and application C, which may be an HTTP server and an FTP server, respectively. Subscriber 2 is hosting three different services, namely, applications B, D, and E.

The virtual computing platform 100 further comprises hardware 170, such as a processing unit 171 for performing action with the aid of memory 172 and disk 173. The hardwire further comprises a network interface 174 for accessing the Internet and/or other networks.

Virtual computing platforms are subject to various kinds of attacks, many of which are unique to such platforms. As far as distributed virtual computing platforms described are concerned, it is possible for one hostile subscriber to launch attacks against other subscribers. These attacks are possible since the traffic from one service proxy to another is considered “internal” communication. One such security threat will be more closely described in the following.

It can be understood from the foregoing that one special characteristic of the service platform described in the preceding is that more than one user are sharing the computing and communicating resources. Each of the service proxies is running in sandbox environment (e.g., Java Virtual Machine) and is supposed not to interfere with one another. However, an application running on one service proxy can legitimately send information to another application running on another service proxy. This type of internal traffic is called Inter-process communication (IPC). If an “internal” attacker desires to launch layer-3 (network layer of the well-known OSI model) or layer-4 (transport layer) attacks against other service proxies of the same service platform, this will be rather easy. This is because internal traffic are typically subject to less strict security measures (or none) compared to external traffic, which will typically be filtered by one or more firewalls in the network.

A first service proxy can generate a packet towards another service proxy running on the same service platform, causing it to overload or perform illegal operations. For example, in all IP stack implementations (from different Operating systems, products, etc), the IP layer checks the source and destination IP addresses of an IP packet. If they are the same (which is the case inside a single service platform), then it forwards the packet directly to the receiving application. A malicious service proxy can therefore generate traffic to another service proxy inside the same service platform without considerable difficulties.

In the example shown in FIG. 3, two subscribers, namely Subscriber 1 and Subscriber 2 (not shown), are currently hosting applications on the service platform. Application A and application C are hosted by Subscriber 1 on service proxy 111 (proxy 1), while applications B, D and E are hosted by Subscriber 2 on service proxy 112 (proxy 2). In FIG. 3, the application C is maliciously generating packets to application D. These packets are transmitted from application C to application D through simple IPC communication indicated by the arrow 301 which goes through the operating system 160, but does not reach the network interface 174. This operation may cause overloading on the service platform 100 and the victim service proxy 112, resulting in Denial-of-Service (DoS). A malicious subscriber may also launch any layer-3 or layer-4 attacks against other service proxies running on the same service platform.

One solution to this problem is to run a host firewall inside the service platform and have policy rules specifying that only IP packets with the same source and destination IP addresses will be filtered. By a host firewall is meant a software firewall running in a host machine (here: the service platform) to filter traffic in and out of the host machine. This is sometimes referred to as a personal firewall. However, this solution has several drawbacks. Firstly, the service platform will be slowed down, as it is not designed for network centric operations (which uses network processors, etc). Secondly, a single subscriber may use more than one service proxies, in which case unnecessary filtering for traffic from the same user cannot be avoided. Thirdly, application layer attacks cannot be filtered as a host firewall typically does not filter application layer attacks.

### SUMMARY OF THE INVENTION

It is an object of the invention to provide a better solution for the security problem of virtual computing platforms.

According to a first aspect of the invention there is provided a virtual computing platform for providing subscribers of the virtual computing platform with means for running their applications on the platform instead of running the applications on their personal devices, the virtual computing platform being adapted to route communication directed from a first application of the platform to a second application of the platform via an external security appliance.

Accordingly, to protect the service platform from the threat described in the introductory portion, one basic idea of the invention is to force inter-process communication (IPC) traffic between service proxies owned by different subscribers to route through external security appliance(s) (including firewall, web shield, anti-virus, anti-spam, etc.). As discussed in the foregoing, a host firewall typically can deal with layer-3 or layer-4 attacks only. In an embodiment of the invention, a separate device, for example, an application layer firewall (a web shield or similar for web traffic) is used for application layer attacks. A host firewall is an inefficient solution compared to external security appliances, which have dedicated hardware/software to handle the traffic.

Advantageously, said external security appliances are local devices residing close to the virtual computing platform in question. Yet advantageously, the virtual computing platform comprises rules according to which internal communication of the platform is routed towards a set of external security appliances.

According to a second aspect of the invention there is provided a method for a virtual computing platform providing subscribers of the virtual computing platform with means for running their applications on the platform instead of running the applications on their personal devices, wherein the method comprises: routing communication directed from a first application of the platform to a second application of the platform via an external security appliance.

According to a third aspect of the invention there is provided software for a virtual computing platform providing subscribers of the virtual computing platform with means for running their applications on the platform instead of running the applications on their personal devices, wherein the software comprises:

program code for causing the virtual computing platform to route communication directed from a first application of the platform to a second application of the platform via at least one external security appliance.

The software may be computer program product(s), comprising program code, stored on a medium, such as a memory.

According to a fourth aspect of the invention there is provided a system comprising:

computer means for implementing a virtual computing platform for providing subscribers of the virtual computing platform with means for running their applications on the platform instead of running the applications on their personal devices, the virtual computing platform being adapted to route communication directed from a first application of the platform to a second application of the platform via at least one external security appliance, the system further comprising: said at least one external security appliance for receiving and acting upon said communication routed by the virtual computing platform.

Dependent claims relate to different embodiments of the invention. The subject matter contained by the embodiments and relating to a particular aspect of the invention may be applied to other aspects of the invention mutatis mutandis.

### BRIEF DESCRIPTION OF THE DRAWINGS

Embodiments of the invention will now be described by way of example with reference to the accompanying drawings in which:

FIG. 1 shows the basic framework for a virtual computing platform;

FIG. 2 shows the internal architecture of a virtual computing platform;

FIG. 3 illustrates an inter proxy server attack; and

FIG. 4 illustrates communication in accordance with an embodiment of the invention.

### DETAILED DESCRIPTION

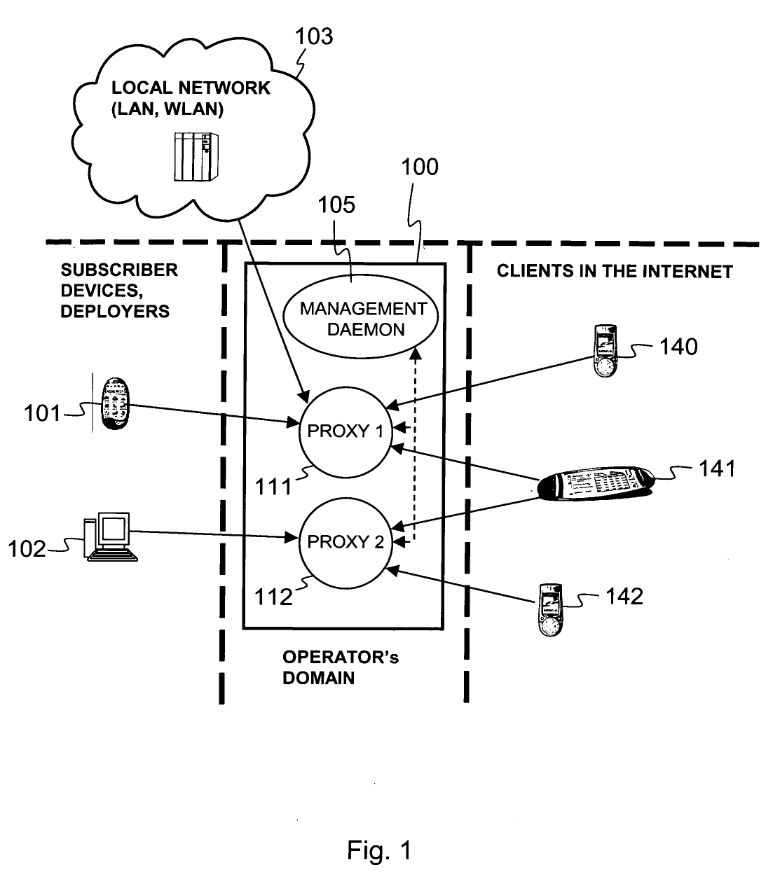

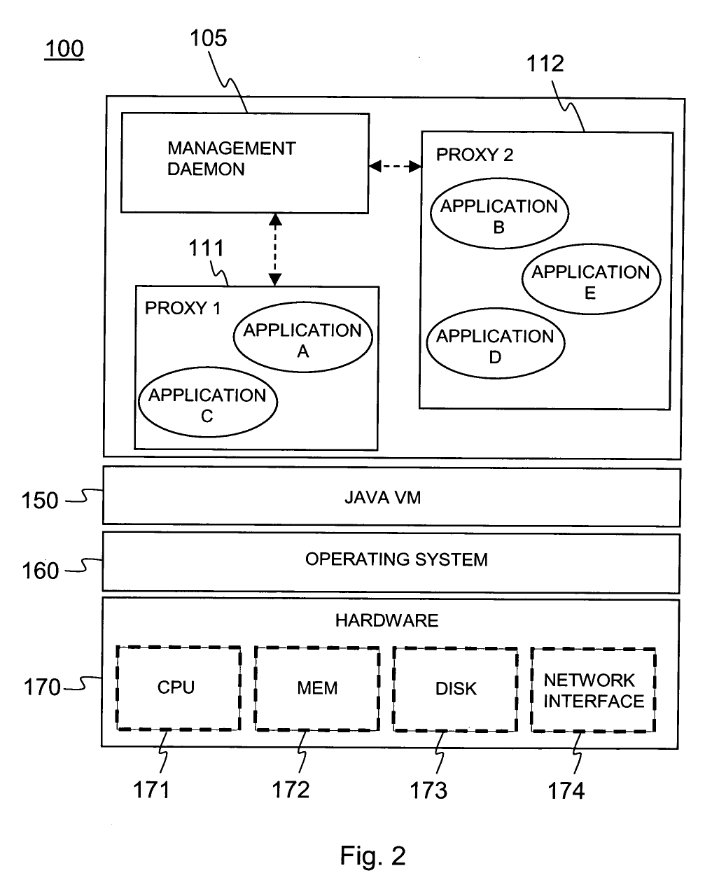

The subject matter contained in the introductory portion of this patent application is used to support the detailed description. Accordingly, an embodiment of the invention also operates in the framework presented in FIG. 1 and in accordance with the internal architecture presented in FIG. 2. To protect the service platform illustrated in FIGS. 1 and 2 from the security threat described in the introductory portion, the basic idea of an embodiment of the invention is to force inter-process communication (IPC) traffic between service proxies owned by different subscribers to route through external security appliances (including firewall, web shield, etc). As such, this “internal” traffic is handled in this embodiment in much the same way as traffic coming from the external network. Apart from layer-3 and layer-4 attacks, which can be filtered by a typical network firewall, application layer attacks can also be avoided by means of an application layer filter, such as web shield.

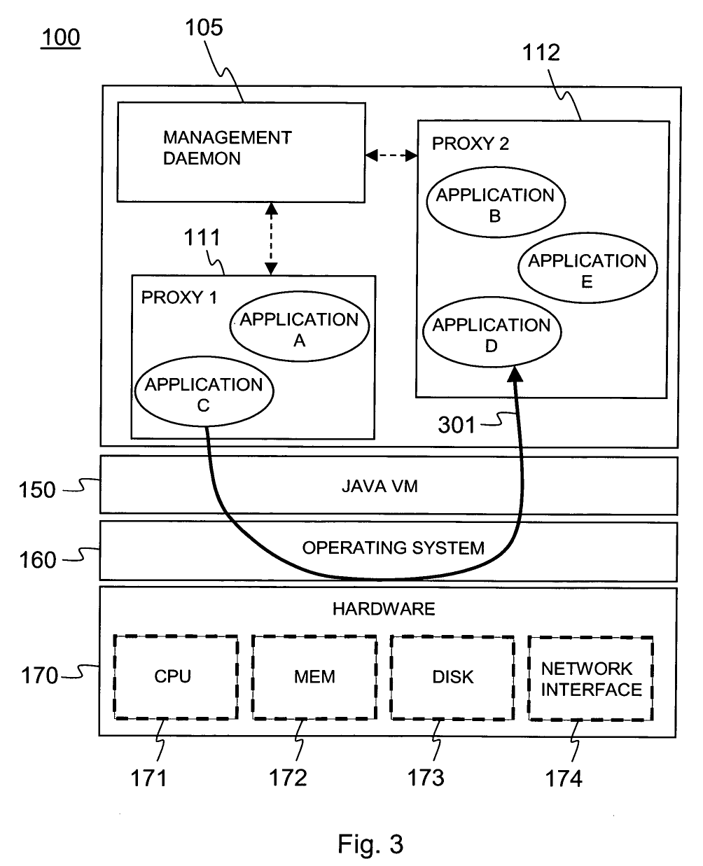

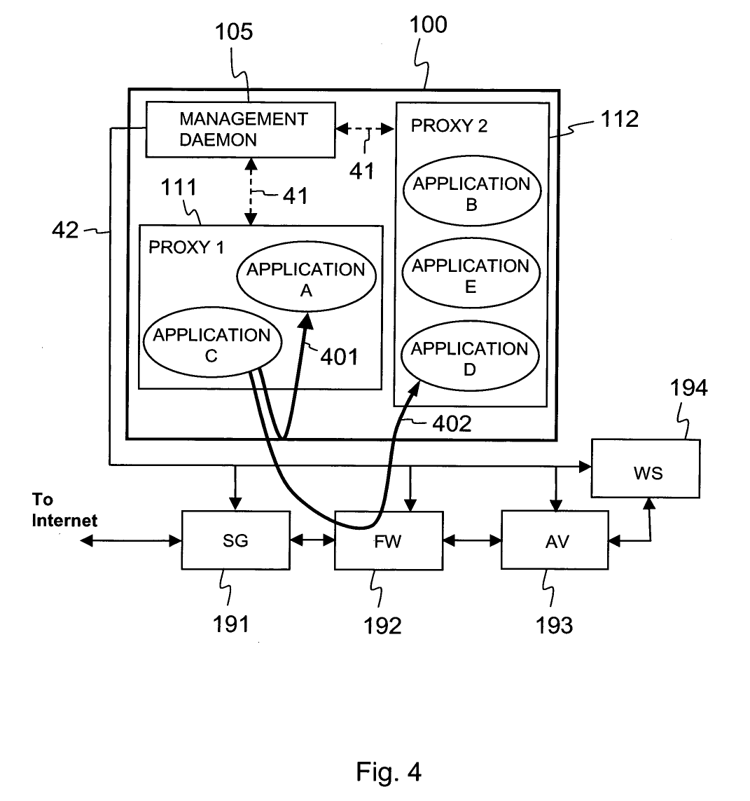

In the present embodiment, an operating system kernel is required to function in a certain way. The operating system kernel is the center piece of the operating system. In terms of FIGS. 2 and 3, the operating system kernel is part of the operating system block 160. Any suitable operating system can be used, for example Linux or Hardened Linux operating system. For the purpose of this embodiment, the operating system kernel contains the codes telling how IPC is handled. According to the present embodiment, IPC is handled according to the following rules:
IPC between different service proxies owned by different subscribers are forced to go through external security appliances (as shown by an arrow 402 in FIG. 4). In this exemplary case, the external security appliances include a security gateway 191, a firewall 192, an anti-virus device 193, and a web shield 194.
IPC between different service proxies that are owned by the same subscriber will not be routed to the external security appliances for better performance (as shown by an arrow 401 in FIG. 4).

In FIG. 4, messages 41 represent control and monitoring messages between service proxies 111, 112 and the service management daemon 105, i.e., interaction between the service proxies 111, 112 and the service management daemon 105. For control purpose, e.g., if a user wants to stop one of his service proxies, a command is sent to the service management daemon, who then sends a control message to the proxy to stop the proxy. For monitoring purpose, e.g., if a subscriber or the service management daemon desires to monitor resource usage of the proxy, this will be effected by using control message(s).

Messages 42 are policy configuration messages sent between the service management daemon 105 and the external security appliances 191-194. Concerning policy configuration messages the firewall 192 is taken as an example. The term “policy” means here, among other things, a set of installed filtering rules that the firewall 192 should use to filter traffic. In the present embodiment, the service management daemon 105 is responsible to send this policy to the firewall 192, basically to configure it such that it will filter in a desired way. For example, if HTTP service is allowed, a certain port (e.g., port number 80) should be opened in a firewall. In the present embodiment, this policy may change over time as well, as a new subscriber joins or when a new proxy is launched. In that case, new rules specific to this subscriber or proxy may need to be communicate to the firewall. The policy configuration works correspondingly for the others of said external security appliances.

In more detail, the operation system kernel can be programmed (a suitable software module comprising desired program code can be added) to operate as follows:
When a user is being added to the service platform, a unique user id/group id is assigned to the user by the OS. This identifier which will identify him/her to be a subscriber of the service platform. A service proxy inherits all the permissions of its owner (subscriber). Here permissions refer to access rights of various resources of the service platform.
When a service proxy attempts to open a communication socket (here the socket means the well-known method of directing data to the appropriate application generally in a TCP/IP network) by making a socket open system call to another service proxy using connection-oriented communication (e.g., TCP and/or SCTP traffic (Stream Control Transmission Protocol)), the kernel checks whether the request process (i.e., the process that makes the request) and the destination process (i.e., the process representing the other endpoint of the communication) belong to the same subscriber, as identified by the user id/group id:
   If YES, “normal” IPC operation will be performed (i.e., traffic will not be forwarded to an externally configured security device (external firewall etc.));
   If NO, a flag is set such that the kernel will forward all traffic to the externally configured security device.
When a service proxy generates a packet (e.g., IP packet) destined for another service proxy on the same service platform using connectionless communication (e.g., IP communication, UDP traffic (User Datagram Protocol)), the kernel determines whether the requesting process and destination process belong to the same subscriber, as identified by the user id/group id:
   If YES, “normal” IPC operation is performed;
   If NO, a flag is set such that the IPC will forward the packet to the externally configured security device.

These modifications to the kernel should not substantially affect application process operations at all, and are transparent to the users.

Embodiments of the invention can be implemented by means of suitable extensions to an existing operating system kernel. As mentioned in the preceding, in accordance with an embodiment of the invention, each subscriber is identified and allocated with unique group and user identification. When a service proxy initiates IPC to another service proxy running on the same machine, the following action presented as a pseudo-code is taken:

```
IF (Communication is connection-oriented (TCP or SCTP)) {
    /* Inside socket_open( ) */
    IF (both sending and receiving process belongs to same user) {
        Do normal processing;
    } ELSE {
        Set flag so that ip_output( ) will force all traffic to the
        externally configured security appliances;
}
ELSE IF (Communication is connection-less (UDP)) {
    /* Inside udp_output( ) */
    IF (Both sending and receiving process belongs to same user) {
        Do normal processing;
    } ELSE {
        Forward the packet to externally configured security appliances;
    }
}
The ip_output( ) function can be modified as follows:
ip_output( ) {
    if (flag is set) {
        Forward the packet to externally configured security appliances;
    } else {
        Do normal processing;
}
```

It should be noted that although it has been described that communication between different service proxies owned by the same subscriber would not be routed to the external security appliances, in other embodiments also this type of communication is passed via the external security appliances. This can be done in order to further improve the security against “attacks” caused by different possibly malfunctioning applications/service proxies owned by the subscriber.

Embodiments of the present invention work with existing operating systems and also with existing firewalls, security gateways and other security devices. The presented mechanism can also be applied to future virtual computing environments.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A virtual computing platform for providing subscribers of the virtual computing platform with means for running their applications on the platform instead of running the applications on their personal devices, the virtual computing platform being adapted to route communication directed from a first application of the platform to a second application of the platform via an external security appliance.

2. The virtual computing platform according to claim 1, wherein the virtual computing platform is configured to force inter-process communication between applications owned by different subscribers to route through said external security appliance.

3. The virtual computing platform according to claim 1, wherein the virtual computing platform comprises a host machine and the external security appliance is a separate device external to the host machine.

4. The virtual computing platform according to claim 1, wherein the virtual computing platform is adapted to route said communication to a close-by external security appliance protecting a perimeter or domain of a network against outside attacks, and wherein the virtual computing platform belongs inside of said perimeter or domain.

5. The virtual computing platform according to claim 1, wherein the virtual computing platform comprises rules according to which internal communication of the platform is routed towards a set of external security appliances.

6. The virtual computing platform according to claim 1, wherein the virtual computing platform is a shared platform in a network.

7. The virtual computing platform according to claim 1, wherein said first and second applications are server applications or proxy servers.

8. The virtual computing platform according to claim 1, wherein said external security appliance is selected from a group comprising: a firewall, a security gateway, an application layer firewall, a web shield, an anti-virus device and an anti-spam device.

9. A method for a virtual computing platform providing subscribers of the virtual computing platform with means for running their applications on the platform instead of running the applications on their personal devices, wherein the method comprises:
routing communication directed from a first application of the platform to a second application of the platform via an external security appliance.

10. The method according to claim 9, wherein the method comprises forcing inter-process communication between applications owned by different subscribers to route through said external security appliance or a set of external security appliances.

11. The method according to claim 9, wherein said communication is routed to a close-by external security appliance protecting a perimeter or domain of a network against outside attacks, and wherein the virtual computing platform belongs inside of said perimeter or domain.

12. Software for a virtual computing platform providing subscribers of the virtual computing platform with means for running their applications on the platform instead of running the applications on their personal devices, wherein the software comprises:
program code for causing the virtual computing platform to route communication directed from a first application of the platform to a second application of the platform via at least one external security appliance.

13. The software according to claim 12, wherein the software comprises:
program code for forcing inter-process communication between applications owned by different subscribers to route through said external security appliance or a set of external security appliances.

14. The software according to claim 12, wherein the software comprises:
program code for causing the virtual computing platform to route said communication to a close-by external security appliance protecting a perimeter or domain of a network against outside attacks, wherein the virtual computing platform belongs inside of said perimeter or domain.

15. A system comprising:
computer means for implementing a virtual computing platform for providing subscribers of the virtual computing platform with means for running their applications on the platform instead of running the applications on their personal devices, the virtual computing platform being adapted to route communication directed from a first application of the platform to a second application of the platform via at least one external security appliance, the system further comprising:
said at least one external security appliance for receiving and acting upon said communication routed by the virtual computing platform.

16. The system according to claim 15, wherein the virtual computing platform is configured to force inter-process communication between applications owned by different subscribers to route through said at least one external security appliance.

17. The system according to claim 15, wherein said at least one external security appliance is a close-by external security appliance protecting a perimeter or domain of a network against outside attacks, and wherein the virtual computing platform belongs inside of said perimeter or domain.
